(19) United States
(12) Patent Application Publication
(10) Pub. No.: US 2025/0247195 A1
(43) Pub. Date: Jul. 31, 2025

(54) Dynamic Preamble Puncturing in Wi-Fi Devices

(71) Applicant: Arista Networks, Inc., Santa Clara, CA (US)

(72) Inventors: Bapiraju Alla, Rajahmundry (IN); Parag Mittal, Pune (IN); Jatin Jayendra Parekh, Mumbai (IN); Nihar Ranjan Behera, Pune (IN)

(21) Appl. No.: 18/422,336

(22) Filed: Jan. 25, 2024

(51) Int. Cl. H04L 5/00; G01S 7/02; H04W 72/02; H04W 72/541; H04W 84/12

(52) U.S. Cl. CPC H04L 5/0062; G01S 7/0232; H04W 72/02; H04W 72/541; H04W 84/12

(57) ABSTRACT

Techniques for implementing dynamic preamble puncturing, or in other words dynamically determining which (if any) subchannels of a wireless channel that a Wi-Fi device is operating on should be punctured based on environmental conditions affecting the channel, are provided. With these techniques, Wi-Fi devices can advantageously operate on wide (e.g., 80, 160, or 320 MHz) wireless channels, even if some portions of those channels are subject to occasional RF interference and/or other availability limitations.

### BACKGROUND

Preamble puncturing (also known as punctured transmission) is a feature supported by the Wi-Fi 7 (802.11be) and Wi-Fi 6 (802.11ax) standards that enables Wi-Fi devices to carve out, or “puncture,” certain portions (i.e., subchannels) of the wireless channels on which the devices operate. By puncturing a subchannel of a wireless channel, a Wi-Fi device can avoid using the radio frequency (RF) spectrum corresponding to that subchannel for Wi-Fi transmissions while continuing to use the remaining channel spectrum.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example environment in accordance with certain embodiments of the present disclosure.

FIG. 2 depicts an example scenario in which a wide channel experiences interference in accordance with certain embodiments of the present disclosure.

FIG. 3 depicts the use of preamble puncturing in the scenario of FIG. 2 in accordance with certain embodiments of the present disclosure.

FIG. 4 depicts a modified version of the environment of FIG. 1 in accordance with certain embodiments of the present disclosure.

FIG. 5 depicts another environment in accordance with certain embodiments of the present disclosure.

FIG. 6 depicts a dynamic preamble puncturing workflow in accordance with certain embodiments of the present disclosure.

FIG. 7 depicts an example Wi-Fi access point in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for implementing dynamic preamble puncturing in Wi-Fi devices, or in other words dynamically determining which (if any) subchannels of a wireless channel that a Wi-Fi device is operating on should be punctured based on environmental conditions affecting the channel. With these techniques, Wi-Fi devices can advantageously operate on wide (e.g., 80, 160, or 320 megahertz (MHz)) wireless channels, even if some portions of those channels are subject to occasional RF interference and/or other availability limitations.

### 1. Example Environment and Solution Overview

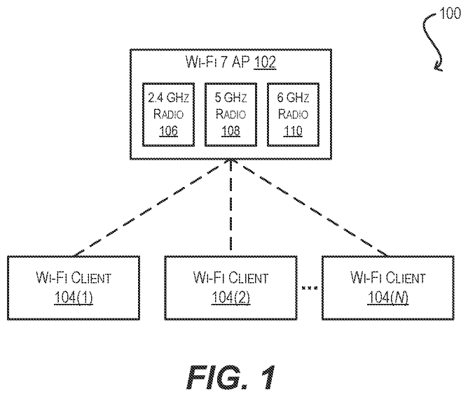

FIG. 1 is a simplified block diagram of an example environment 100 in which the techniques of the present disclosure may be implemented. As shown, environment 100 includes a Wi-Fi access point (AP) 102 that is wirelessly coupled with a number of Wi-Fi client devices (clients) 104(1)-(N). Wi-Fi is a wireless networking technology that has evolved over several versions and is standardized via a set of IEEE (Institute of Electrical and Electronics Engineers) standards known as the 802.11x standards. The most recent version of this technology is Wi-Fi 7, which is defined in the 802.11be standard. Earlier versions include Wi-Fi 6 (802.11ax), Wi-Fi 5 (802.11ac), and so on.

In FIG. 1, Wi-Fi AP 102 is a Wi-Fi 7 device and thus supports Wi-Fi transmissions over three wireless bands per the 802.11be standard: a 2.4 gigahertz (GHz) band, a 5 GHz band, and a 6 GHz band. For example, Wi-Fi AP 102 includes a 2.4 GHz radio 106 dedicated for sending/receiving Wi-Fi signals over the 2.4 GHz band, a 5 GHz radio 108 dedicated for sending/receiving Wi-Fi signals over the 5 GHz band, and a 6 GHz radio 110 dedicated for sending/receiving Wi-Fi signals over the 6 GHz band. It is also possible for Wi-Fi AP 102 to have multiple radios per wireless band. Each wireless band corresponds to a range of the RF spectrum that has been licensed for Wi-Fi use. In the United States, the 2.4 GHz band covers the RF range of 2400 to 2495 megahertz (MHz), the 5 GHz band covers the RF range of 5170 to 5835 MHz, and the 6 GHz band covers the RF range of 5925 to 7125 MHZ.

For each radio 106/108/110, Wi-Fi AP 102 selects and uses a wireless channel (hereinafter simply “channel”) within that radio's wireless band for communicating with Wi-Fi clients 104(1)-(N), where the channel is a specific subrange of frequencies in the wireless band that the radio can operate on at a given point in time. While the exact number of channels available in each wireless band varies based on regional regulatory standards and the Wi-Fi version being used, the 5 GHZ and 6 GHz bands have more available channels than the 2.4 GHZ band due to their larger spectrum sizes. Further, the width of each channel in the 2.4 band is limited to 20 MHz or 40 Mhz, whereas the widths of the channels in the 5 GHz band range from 20 MHz to 160 MHz and the widths of the channels in the 6 GHz band range from 20 MHz to 320 MHz. Any channel that is wider than 40 MHz (e.g., 80 MHz, 160 MHz, or 320 MHz) is referred to herein as a wide channel.

Generally speaking, wide channels provide a higher data throughput rate (i.e., bandwidth) than standard 20 MHz channels because bandwidth scales with channel width. Accordingly, it is preferable for Wi-Fi AP 102 to select and use wide channels on the 5 GHZ and 6 GHz bands whenever possible. However, a wide channel is more frequently affected by RF interference and other conflicts (e.g., RADAR activity) than a 20 MHz channel because it spans a larger RF range. This can adversely affect the performance of the wide channel as a whole and in some cases can knock the entire channel out of service.

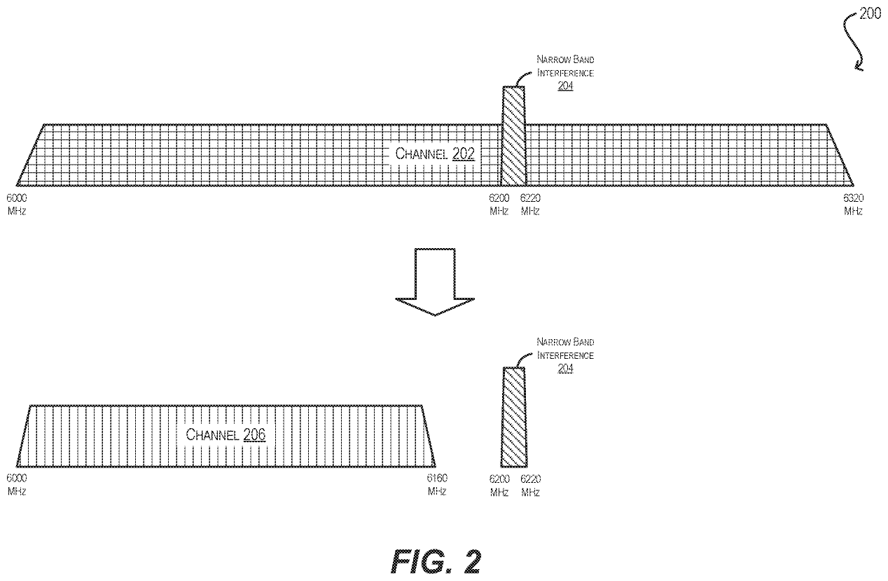

By way of example, FIG. 2 depicts a scenario 200 in which a 320 MHz channel (reference numeral 202) used by Wi-Fi AP 102 on the 6 GHz band experiences narrow band interference (reference numeral 204) in the latter half of the channel spectrum. Channel 202 is shown as spanning the RF range of 6000 to 6320 MHz, but this is for illustrative purposes only and not meant to correspond to an actual 320 MHz channel in the 6 GHz band. Narrow band interference 204 may come from nearby Wi-Fi devices or non-Wi-Fi sources and falls within a 20 MHz range between 6200 and 6220 MHZ.

As depicted in scenario 200, narrow band interference 204 is severe enough that Wi-Fi AP 102 is no longer able to use channel 202. Accordingly, the Wi-Fi AP falls back to using a 160 MHz channel (reference numeral 206) that covers only the first half of channel 202's spectrum. This outcome is undesirable because an interference/noise signal that is less than 10% of the width of channel 202 has caused the entirety of that channel to become unavailable (and has effectively halved the bandwidth usable by Wi-Fi AP 102 on the 6 GHz band).

To overcome the foregoing issue, Wi-Fi AP 102 can employ a Wi-Fi 7/6 feature known as preamble puncturing. As mentioned previously, preamble puncturing enables Wi-Fi devices to puncture—or in other words, carve out-one or more portions (i.e., subchannels) of a wide channel, such that only the non-punctured portions of the channel are used for Wi-Fi transmissions. Each punctured subchannel is at least 20 MHz in width. This reduces the overall bandwidth of the wide channel by the punctured amount but enables the channel to remain available/usable in the face of pockets of interference.

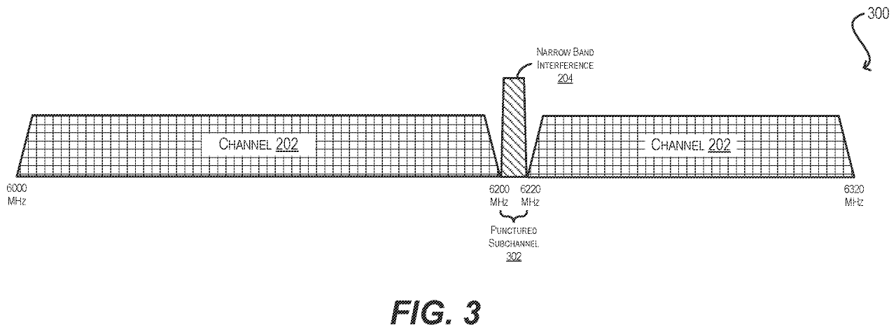

For example, FIG. 3 depicts a scenario 300 involving channel 202 of FIG. 2 where the same narrow band interference 204 is present, but Wi-Fi AP 102 has punctured a subchannel of channel 202 (reference numeral 302) that spans the RF range affected by this interference (i.e., 6200 to 6220 MHZ). As can be seen in FIG. 3, because narrow band interference 204 is no longer a problem due to the puncturing of subchannel 302, Wi-Fi AP 102 can continue to use channel 202 (with a slightly reduced total bandwidth of 300 MHZ), rather than falling back to significantly narrower channel 206.

For clarity, it should be noted that Wi-Fi APs may not puncture arbitrary subchannels of a wide channel under the Wi-Fi 7 and Wi-Fi 6 standards. Instead, they should select and apply a puncturing pattern from a predefined group of such patterns, where each puncturing pattern specifies one or more subchannels that will be punctured in accordance with the pattern. For example, the Wi-Fi 7/6 standards define one group of puncturing patterns for channels that are 80 MHz wide, another group of puncturing patterns for channels that are 160 MHz wide, and so on. Accordingly, in scenario 300 of FIG. 3, it is assumed that Wi-Fi AP 102 has selected and applied a puncturing pattern to channel 202 that specifies subchannel 302 as the only puncturing target. In cases where none of the predefined puncturing patterns exactly match the subchannel(s) that need to be punctured, the closest pattern can be selected.

One significant limitation with current Wi-Fi APs that implement preamble puncturing is that they generally require an administrator or other user to statically define which subchannels of a given channel should be punctured (or more precisely, which puncturing pattern to use for the channel) as part of the AP's configuration. This static approach is not particularly useful or effective because it is difficult for such individuals to know a priori which subchannels will experience interference or other conflicts at AP runtime, and those issues can come or go over time. For example, if the administrator/user chooses to puncture one or more subchannels that do not end up experiencing any interference (or if interference that previously affected those subchannels goes away), the bandwidth of those subchannels will be unnecessarily wasted/lost. Conversely, if the administrator/user erroneously fails to puncture one or more subchannels that are (or later become) noisy, the AP may need to fall back to a narrower channel, thereby eliminating the main advantage of the feature.

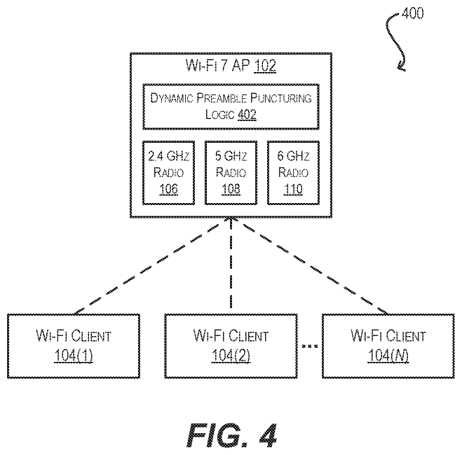

To address this limitation, FIG. 4 depicts a modified version 400 of environment 100 of FIG. 1 that includes within Wi-Fi AP 102 a new, dynamic preamble puncturing logic component 402 according to certain embodiments. Dynamic preamble puncturing logic 402 can be implemented in software, in hardware, or via a combination thereof. For example, in one set of embodiments dynamic preamble puncturing logic 402 can be implemented as part of an operating system or user application that runs on a central processing unit (CPU) of Wi-Fi AP 102.

As described in further detail below, dynamic preamble puncturing logic 402 can enable Wi-Fi AP 102 to periodically evaluate, for each of a set of “target” channels that the AP is operating on (i.e., channels that exceed a threshold width), real-time or near real-time information regarding environmental factors affecting the channel. Such environmental factors-which may include, e.g., Wi-Fi/non-Wi-Fi interference and RADAR activity detected on the target channel—can be collected by Wi-Fi AP 102 itself and/or received from other, nearby Wi-Fi APs. Based on this evaluation, dynamic preamble puncturing logic 402 can enable Wi-Fi AP 102 to determine whether the target channel should be punctured and, if so, which puncturing pattern should be used. In this way, Wi-Fi API 102 can dynamically adjust the puncturing patterns that are applied to its channels in response to runtime operating conditions and thereby make most efficient and effective use of the preamble puncturing feature. For instance, with respect to scenarios 200 and 300 of FIGS. 2 and 3, dynamic preamble puncturing logic 402 can enable Wi-Fi AP 102 to detect that narrow band interference 204 is adversely affecting 320 MHz channel 202 and dynamically apply a puncturing pattern to channel 202 that includes subchannel 302.

It should be appreciated that FIGS. 1-4 and the description above are illustrative and not intended to limit embodiments of the present disclosure. For example, although Wi-Fi AP 102 is described as a Wi-Fi 7 device, in alternative embodiments Wi-Fi AP 102 may be a Wi-Fi 6/6E device or a Wi-Fi device implementing some other/future Wi-Fi version that supports preamble puncturing.

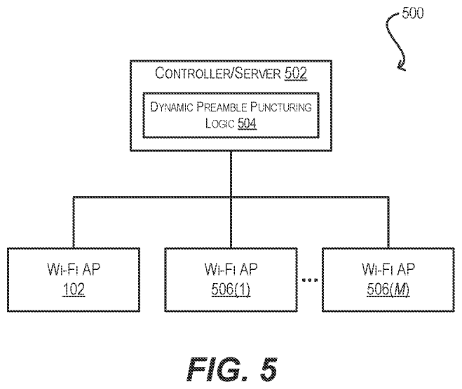

Further, although FIG. 4 depicts dynamic preamble puncturing logic 402 as residing on Wi-Fi AP 102, in alternative embodiments this logic may reside on a computer system (e.g., a central controller or server) that is configured to manage a cluster of Wi-Fi APs including AP 102. An example of such an embodiment 500 is presented in FIG. 5, which shows a controller/server 502 (comprising a dynamic preamble puncturing logic component 504 similar to component 402 of FIG. 4) that is communicatively coupled, directly or indirectly, with Wi-Fi AP 102 and a plurality of other Wi-Fi 7 APs 506(1)-(M).

In these embodiments, controller/server 502 can execute a separate instance of dynamic preamble puncturing logic 504 on behalf of each Wi-Fi AP 102/506(1)-(M). For instance, on a periodic basis, controller/server 502 can (1) receive, from each Wi-Fi AP, information regarding the environmental factors affecting the AP's target channels, (2) determine what (if any) puncturing patterns should be applied to those channels based on the received information, and (3) transmit the determined puncturing patterns to the Wi-Fi AP. Each Wi-Fi AP can then apply the puncturing patterns received from controller/server 502.

### 2. Dynamic Preamble Puncturing Workflow

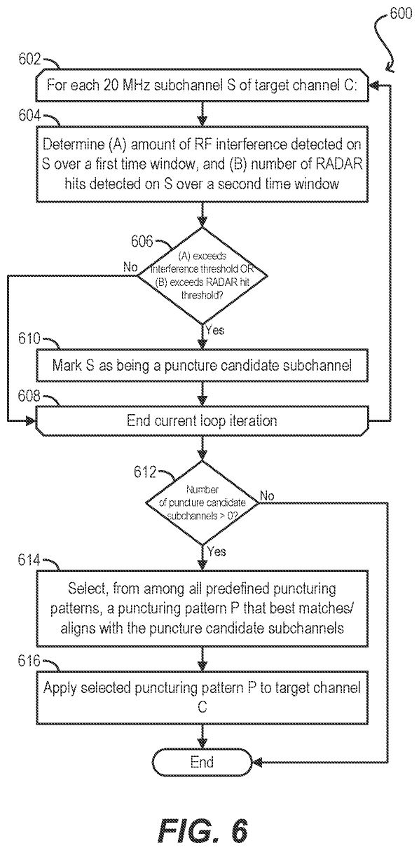

FIG. 6 depicts a workflow 600 that may be performed by Wi-Fi AP 102 of FIG. 4 using its dynamic preamble puncturing logic 402 for dynamically puncturing a target channel C it is operating on according to certain embodiments. A target channel is a channel that has a width greater than a threshold width (e.g., 40 MHz). This threshold width can be configured by an administrator or user of Wi-Fi AP 102. In scenarios where Wi-Fi AP 102 is concurrently operating on multiple target channels via multiple radios (which will typically be the case for Wi-Fi 7 APs), Wi-Fi AP 102 can run multiple concurrent instances of workflow 600, one instance per channel/radio.

It is assumed that workflow 600 is repeated by Wi-Fi AP 102 on a periodic basis, referred to as the preamble puncturing assessment (PPA) interval, throughout the AP's runtime. Like the threshold width described above, the PPA interval is user configurable. One example value for the PPA interval is 30 minutes. Generally speaking, a very short PPA interval such as 10 seconds is undesirable as it will increase the computational load on Wi-Fi AP 102 and may cause the puncturing pattern for target channel C to change too often. On the other hand, a very long PPA interval such as 24 hours is also undesirable as it will render the dynamic puncturing mechanism unresponsive to typical changes in RF conditions.

Further, it is assumed that Wi-Fi AP 102 is continuously collecting information regarding the amount of RF interference detected on the 20 MHz subchannels of target channel C, as well as continuously monitoring for RADAR activity on those subchannels. As mentioned previously, in certain embodiments some of this information may be collected by other nearby APs and communicated to Wi-Fi AP 102 at regular intervals.

Starting with step 602, Wi-Fi AP 102 can enter a loop for each 20 MHz subchannel S of target channel C. Within the loop, Wi-Fi AP 102 can determine (A) the amount of RF interference (both from Wi-Fi and non-Wi-Fi sources) detected on subchannel S over a first time window, and (B) the number of RADAR hits (i.e., pulses) detected on subchannel S over a second time window (step 604). (A) may be the percentage of the first time window where Wi-Fi AP 102 cannot access/use subchannel S due to RF interference, and the first time window may be, e.g., the last five seconds. The second time window may be, e.g., the last 12 or 24 hours. Wi-Fi AP 102 can make these determinations based on the collected interference and RADAR activity information noted above.

At step 606, Wi-Fi AP 102 can check whether (A) exceeds an interference threshold or (B) exceeds a RADAR hit threshold. These thresholds can be configured by an administrator or user of Wi-Fi AP 102, with certain manufacturer-configured default values. For example, the interference threshold may be 50%.

If the answer at step 606 is no, Wi-Fi AP 102 can directly proceed to the end of the current loop iteration (step 608). However, if the answer at step 606 is yes, Wi-Fi AP 102 can mark subchannel S as being a puncture candidate subchannel (step 610) before proceeding to the end of the current loop iteration.

Upon processing all of the subchannels of target channel C in accordance with steps 602-610, Wi-Fi AP 102 can check whether the number of puncture candidate subchannels identified via that processing is greater than zero (step 612). If the answer is no, workflow 600 can end.

However, if the answer at step 612 is yes, Wi-Fi AP 102 can select, from among all of the puncturing patterns defined for the channel width of target channel C, a puncturing pattern P that best matches/aligns with the puncture candidate subchannels (step 614). Ideally, selected puncturing pattern P is one that allows all of the puncture candidate subchannels to be punctured while minimizing the puncturing of other, non-puncture candidate subchannels. For example, if target channel C is an 80 MHz channel and there is a single puncture candidate subchannel corresponding to the last 20 MHz of C, Wi-Fi AP 102 would ideally select a puncturing pattern that punctures only that last 20 MHz.

In certain embodiments, if Wi-Fi AP 102 cannot find any puncturing pattern that allows all of the puncture candidate subchannels to be punctured, Wi-Fi AP 102 can select a puncturing pattern that allows the “worst” puncture candidate subchannels to be punctured, or in other words the puncture candidate subchannels that experienced the highest amount of RF interference and/or the highest number of RADAR hits during the first and second time windows respectively.

Finally, at step 616, Wi-Fi AP 102 can apply the selected puncturing pattern P to target channel C and workflow 600 can end. Step 616 can involve sending a preamble puncturing command to a software driver of the AP radio operating on target channel C that identifies puncturing pattern P. Upon receiving this command, the radio driver can cause the radio to apply puncturing pattern P to its Wi-Fi transmissions over the channel.

### 3. Example Wi-Fi AP

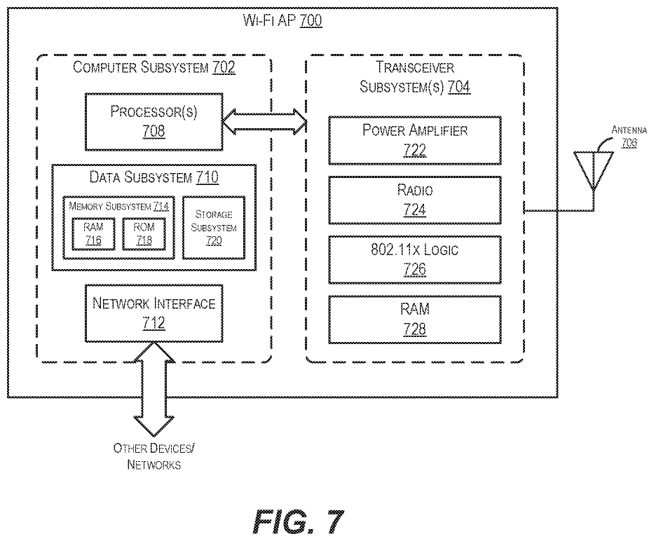

FIG. 7 is a simplified block diagram of an example Wi-Fi AP 700 according to certain embodiments. Wi-Fi AP 700 can be used to implement Wi-Fi AP 102 described in the foregoing sections. As shown, Wi-Fi AP 700 comprises a computer subsystem 702 and one or more transceiver/radio subsystems 704, each coupled with a corresponding antenna 706. In the case where Wi-Fi AP 700 supports multiple wireless bands, Wi-Fi AP 700 can include multiple transceiver/radio subsystems (with at least one transceiver/radio subsystem per band).

Computer subsystem 702 includes one or more processors (e.g., CPUs) 708, a data subsystem 710, and a network interface 712. Processor(s) 708 can communicate with transceiver subsystem 704 to configure and otherwise control the operations of that subsystem. Data subsystem 710 includes a memory subsystem 714 comprising a random-access memory (RAM) 716 for storage of instructions/data during program execution and a read-only memory (ROM) 718 in which fixed instructions are stored. Data subsystem 710 further includes a storage subsystem 720 that provides persistent (i.e., non-volatile) storage for program and data files. The components of data subsystem 710 represent non-transitory computer-readable storage media storing program code and/or data that, when executed by computer subsystem 702, can cause processor(s) 708 to perform operations in accordance with embodiments of the present disclosure. For example, data subsystem 710 can store program code implementing dynamic preamble puncturing logic 402 of FIG. 4. In addition, data subsystem 710 can store the puncturing patterns used/accessed by AP 102 as part of workflow 600 of FIG. 6. Network interface 712 allows for communication between Wi-Fi AP 700 and other devices or networks.

Each transceiver subsystem 704 includes a power amplifier 722, a radio 724, an IEEE 802.11x logic component 726, and a RAM 728. Power amplifier 722 provides power to radio 724, for example, in order to transmit and receive Wi-Fi signals via corresponding antenna 706. IEEE 802.11x logic 726 comprises data processing elements such as an ASIC (application-specific integrated circuit), an FPGA (field-programmable gate array), a digital processing unit, etc. that are configured to process Wi-Fi signals received/transmitted via radio 724 in accordance with one or more of the IEEE 802.11x standards. Finally, RAM 728 provides buffers and other data structures to support the transmission and reception of those signals.

It should be appreciated that Wi-Fi AP 700 is illustrative and many other configurations having more or fewer components than Wi-Fi AP 700 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a Wi-Fi device or a computer system in communication with a Wi-Fi device, the method comprising:
for each of a plurality of subchannels of a channel on which the Wi-Fi device is operating:
determining, based on interference information collected for the channel, an amount of Wi-Fi and non-Wi-Fi interference detected on the subchannel over a first time window;
determining, based on RADAR activity information collected for the channel, a number of RADAR hits detected on the subchannel over a second time window; and
upon determining that the amount of Wi-Fi and non-Wi-Fi interference detected on the subchannel exceeds a first threshold or the number of RADAR hits detected on the subchannel exceeds a second threshold, marking the subchannel as being a puncture candidate subchannel; and
upon determining that a number of puncture candidate subchannels exceeds zero:
selecting, from among a plurality of puncturing patterns, a puncturing pattern based on the puncture candidate subchannels; and
causing the selected puncturing pattern to be applied to the channel.

2. The method of claim 1 wherein the channel is greater than 40 MHz in width.

3. The method of claim 1 wherein each subchannel in the plurality of subchannels is at least 20 MHz in width.

4. The method of claim 1 wherein the method is executed for each of a plurality of channels on which the Wi-Fi device is operating.

5. The method of claim 1 wherein the method is repeated on a periodic basis during runtime of the Wi-Fi device.

6. The method of claim 1 wherein selecting the puncturing pattern based on the puncture candidate subchannels comprises selecting one of the plurality of puncturing patterns that allows all of the puncture candidate subchannels to be punctured.

7. The method of claim 1 wherein the computer system is in communication with a plurality of Wi-Fi devices and executes the method with respect to each of the plurality of Wi-Fi devices.

8. A Wi-Fi device comprising:
a processor; and
a computer-readable storage medium having stored thereon program code that, when executed by the processor, causes the processor to:
for each of a plurality of subchannels of a channel on which the Wi-Fi device is operating:
determine, based on interference information collected for the channel, an amount of Wi-Fi and non-Wi-Fi interference detected on the subchannel over a first time window;
determine, based on RADAR activity information collected for the channel, a number of RADAR hits detected on the subchannel over a second time window; and
upon determining that the amount of Wi-Fi and non-Wi-Fi interference detected on the subchannel exceeds a first threshold or the number of RADAR hits detected on the subchannel exceeds a second threshold, marking the subchannel as being a puncture candidate subchannel; and
upon determining that a number of puncture candidate subchannels exceeds zero:
select, from among a plurality of puncturing patterns, a puncturing pattern based on the puncture candidate subchannels; and
cause the selected puncturing pattern to be applied to the channel.

9. The Wi-Fi device of claim 8 wherein the Wi-Fi device is a Wi-F 6 or Wi-Fi 7 access point.

10. The Wi-Fi device of claim 8 wherein the processor is further configured to:
collect the interference information and the RADAR activity information on a continuous basis during runtime of the Wi-Fi device.

11. The Wi-Fi device of claim 8 wherein the channel is a wide channel on a 5 GHz band or a 6 GHz band.

12. The Wi-Fi device of claim 8 wherein a subset of the interference information or the RADAR activity information is received from other Wi-Fi devices in a vicinity of the Wi-Fi device.

13. The Wi-Fi device of claim 8 wherein the plurality of puncturing patterns are defined in an 802.11x standard supported by the Wi-Fi device, and where each of the plurality of puncturing patterns specifies a predefined set of subchannels to be punctured.

14. The Wi-Fi device of claim 8 wherein the processor causes the selected puncturing pattern to be applied to the channel by transmitting a preamble puncturing command identifying the selected puncturing pattern to a driver of a radio of the Wi-Fi device that is operating on the channel.

15. A method performed by a Wi-Fi device or a computer system in communication with a Wi-Fi device, the method comprising, during runtime of the Wi-Fi device:
for each of a plurality of subchannels of a channel on which the Wi-Fi device is operating:
determining, based on interference information collected for the channel, an amount of Wi-Fi and non-Wi-Fi interference detected on the subchannel over a time window; and
upon determining that the amount of Wi-Fi and non-Wi-Fi interference detected on the subchannel exceeds a threshold, marking the subchannel as being a puncture candidate subchannel; and
upon determining that a number of puncture candidate subchannels exceeds zero, causing the puncture candidate subchannels to be punctured from the channel.

16. The method of claim 15 further comprising, for each of the plurality of subchannels of a channel:
determining, based on RADAR activity information collected for the channel, a number of RADAR hits detected on the subchannel over another time window.

17. The method of claim 16 wherein the subchannel is further marked as being a puncture candidate subchannel upon determining that the number of RADAR hits detected on the subchannel exceeds another threshold.

18. The method of claim 16 wherein causing the puncture candidate subchannels to be punctured from the channel comprises:
selecting, from among a plurality of puncturing patterns, a puncturing pattern based on the puncture candidate subchannels; and
causing the selected puncturing pattern to be applied to the channel.

19. The method of claim 18 wherein selecting the puncturing pattern based on the puncture candidate subchannels comprises selecting one of the plurality of puncturing patterns that allows all of the puncture candidate subchannels to be punctured.

20. The method of claim 18 wherein there is no puncturing pattern in the plurality of puncturing patterns that allows all puncturing candidate subchannels to be punctured, and wherein the selecting ensures that the selected puncturing pattern includes a subset of the puncture candidate subchannels experiencing the highest amount of Wi-Fi and non-Wi-Fi interference over the time window and/or the highest number of RADAR hits over said another time window.
